(19) United States
(12) Patent Application Publication
(10) Pub. No.: US 2007/0200425 A1
(43) Pub. Date: Aug. 30, 2007

(54) Retrofit second input brake master cylinder cap

(75) Inventor: Daniel S. Youngwerth, Boise, ID (US)

Correspondence Address: Daniel S. Youngwerth, 110 E 43rd St, Garden City, ID, 83714, US

(73) Assignee: Rekluse Motor Sports, Inc., Garden City, ID (US)

(21) Appl. No.: 11/363,303

(22) Filed: Feb. 27, 2006

(51) Int. Cl. B60T 13/00

(52) U.S. Cl. 303/9.64; 188/344; 188/345

(57) ABSTRACT

An alternative cap for an integrated reservoir brake master cylinder. The improved cap provides an input for a second brake master cylinder and a novel sealing means. The sealing means bypasses the integrated brake reservoir's sight window and cap allowing hydraulic pressure from a second master cylinder to actuate the rear brake while preventing the integrated brake reservoirs sight window or cap from leaking oil under hydraulic pressure.

CROSS-REFERENCE TO RELATED APPLICATIONS

This application claims the benefit of the provisional patent application 60/655,636 filed on Feb. 23, 2005.

### FEDERALLY SPONSORED RESEARCH

Not Applicable.

### BACKGROUND OF THE INVENTION

1. Field of the Invention

Generally relates to motorcycles and ATVs equipped with hydraulically actuated rear brake systems. More particularly, hydraulic rear brake systems that can be actuated by the hand or foot.

2. Description of Related Art

Motorcycles and ATVs conventionally use a foot actuated rear brake and right hand operated front brake. Recently, retrofit automatic clutch systems have become available that reduce or eliminate the need for the original left-handed actuated clutch release lever. Many riders find the ability to actuate the rear brake with the left hand a desirable feature. Additionally, many riders would like to be able to retain the use of the original foot actuated brake lever. Therefore a need exists for a retrofit left hand actuated rear brake that retains the use of the original foot actuated brake components.

Dual actuated (foot and left hand) are common in the prior art. Typically, these systems use cable actuation for booth foot and hand or a combination of cable and hydraulic actuation. Additionally, some dual systems utilize two separate hydraulic system (master cylinder and slave cylinder) acting on a single brake disk.

Cable-based brake activation systems do not provide the level of braking performance that users are accustomed to. Adding a second hydraulic brake actuation is costly and difficult to adapt to many different type of motorcycles.

Therefore, a need exists for a simple means to actuate a single brake slave cylinder from both foot and left hand master cylinders. To keep cost and weight low, the system needs to adapt to the brake components included on the motorcycle or ATV and be simple for the user to install.

### SUMMARY OF THE INVENTION

A novel apparatus provides a means to retrofit a second brake master cylinder to an integrated reservoir, foot brake master cylinder originally included with the vehicle.

A typical motorcycle or ATV hydraulic rear brake system consists of a foot-actuated master cylinder, a hydraulic fluid reservoir, a slave cylinder and a hose to connect the master cylinder and slave cylinder. Typically the master cylinder utilizes a plunger connected to a foot brake lever to push the hydraulic fluid to actuate the slave cylinder. The plunger operates inside of a bore with an output to the brake hose and a passage to the hydraulic reservoir.

When the plunger is in the non-activated state, the passage to the hydraulic reservoir is open. The open passage from the hydraulic reservoir to the brake hose allows the hydraulic system to be filled with additional hydraulic fluid to compensate for brake pad wear. When the plunger is activated, it closes off the passage to the hydraulic reservoir and actuates the slave cylinder through hydraulic pressure.

The possibility exists to connect a second master cylinder to the rear brake system through the passage of the hydraulic reservoir of the foot-actuated brake master cylinder. When the plunger of the first master cylinder is in the non-activated state, the second master cylinder can provide hydraulic pressure to the slave cylinder through the passage of the hydraulic reservoir of the first master cylinder. Consequently, the passage to the hydraulic reservoir of the second master cylinder will fill the hydraulic system with additional hydraulic fluid to compensate for brake pad wear.

Many of the newer motorcycles and ATV utilize a brake master cylinder with an integrated hydraulic reservoir. The integrated hydraulic reservoir typically includes a removable cap to add hydraulic fluid and a sight glass to inspect the hydraulic fluid level. The integrated hydraulic reservoir is not designed to operate under hydraulic pressure. Simply replacing original cap with a cap that includes a fitting to adapt a hose will typically result in leaking of the hydraulic fluid at the cap or at the sight glass.

The present invention replaces the original master cylinder cap with a retrofit alternative input brake master cylinder cap. This improved cap includes an integrated hose fitting, a sleeve and sealing means. The improved cap utilizes the original cap's fastener means, allows a second master cylinder to be connected through a second brake hose to the integrated hose fitting and bypasses integrated hydraulic reservoir by providing a means to seal the pressurized hydraulic fluid at or near the base of the integrated hydraulic reservoir. Bypassing the integrated hydraulic reservoir prevents pressurized hydraulic fluid from leaking through the cap or sight glass.

### BRIEF DESCRIPTION OF THE DRAWINGS

The present invention will become more fully understood from the detailed description given herein and the accompanying drawing which are given by way of illustration only, and thus are not limitative of the present invention.

FIG. 1 Shows cross section of a typical brake master cylinder with integrated reservoir.

FIG. 2 Shows cross section of a typical brake master cylinder with integrated reservoir with the retrofit second input master cylinder cap installed.

### DETAILED DESCRIPTION OF THE PREFERRED EMBODIMENTS

The following is a detailed description of the preferred embodiment as it would appear on a modem motorcycle/ATV.

### Description of the Elements:

1) Master Cylinder Main Body
2) Piston Chamber
3) Piston
4) Reservoir Chamber
5) Reservoir Upper End
6) Reservoir Lower End
7) Sight Window
8) Fluid Passing Port
9) Fasteners
10) Cap
11) Sleeve Body
12) Sleeve Passageway
13) Sleeve O-Ring
14) Sleeve Cap
15) Brake Hose
16) Second Master Cylinder

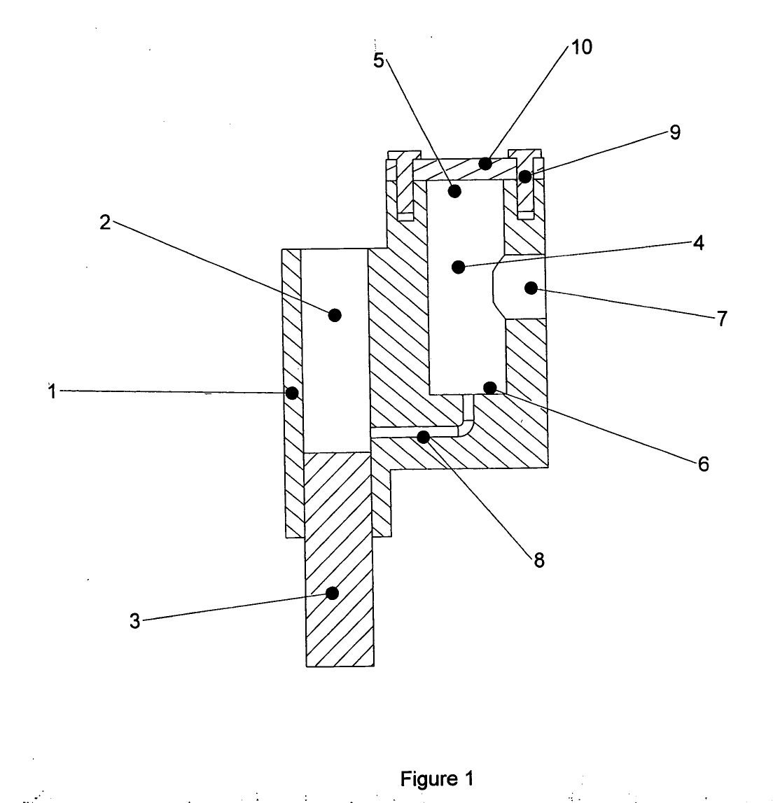

FIG. 1 illustrates a typical brake master cylinder with integrated reservoir. The master cylinder main body 1 contains a piston chamber 2 that holds the piston 3. A fluid passing port 8 connects the piston chamber 2 and reservoir chamber 4 and allows fluid to pass. A cap 10 is provided to allow fluid to be added and a sight window 7 allows the operator to easily check the fluid level. When the piston 3 is moved past the fluid passing port 8, the piston chamber 2 is sealed and hydraulic pressure can be built in the piston chamber 2 by the piston 3. When the piston 3 moves back past the fluid passing port 8, fluid from the reservoir chamber 4 can refill any displaced fluid in the piston chamber 2.

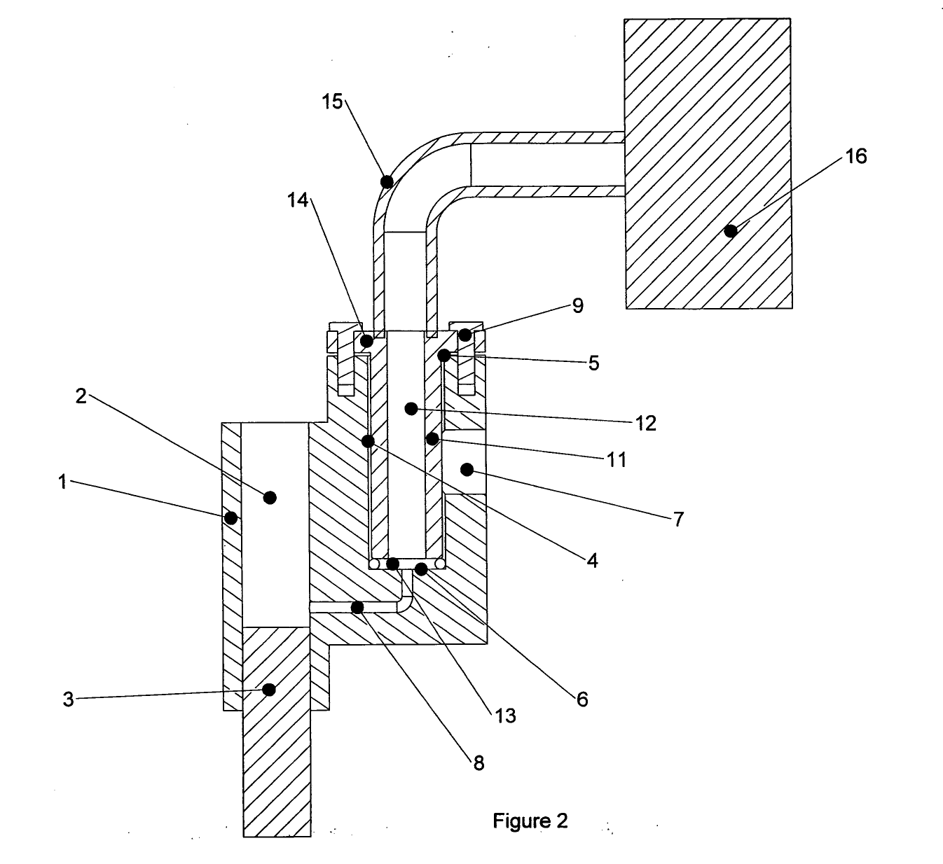

FIG. 2 illustrates a typical brake master cylinder with integrated reservoir with the second input brake master cylinder installed and connected to a second master cylinder. The sleeve body 11 is received into the reservoir chamber 4. The sleeve o-ring 13 provides a seal between the fluid passing port 8 at the reservoir lower end 6 and the sleeve passageway 12 preventing fluid under hydraulic pressure from escaping into the reservoir chamber 4 and potentially escaping past the sight window 7 or the cap 10. Typically the sight window 7 and cap 10 are not designed to accept hydraulic pressure. The sleeve cap 14 is coupled to reservoir upper end 5 with the fasteners 9.

The sleeve passageway 12 allows fluid to pass from the second master cylinder 16, through the brake hose 15, through the fluid passing port 8 and into the reservoir chamber 4. When the piston 3 is moved past the fluid passing port 8, the piston chamber 2 is sealed and hydraulic pressure can be built in the piston chamber 2 by the piston 3. When the piston 3 moves back past the fluid passing port 8, fluid from the second master cylinder 16 can refill any displaced fluid in the piston chamber 2. When the piston 3 is in the back position (fluid passing port 8 is open) the second master cylinder 16 can provide pressure to the piston chamber 2.

What is claimed is:

1. A second input brake master cylinder device comprising:
a first master cylinder including:
a main body having a major axis, the main body including a chamber for receiving a piston;
a reservoir chamber integrally connected to the main body, the reservoir chamber having an elongated shape and a major axis oriented substantially parallel to the major axis of the main body, the reservoir having a reservoir upper end and a reservoir lower end, the reservoir having a sight window positioned between said reservoir upper end and said reservoir lower end, said reservoir lower end having a fluid passing port, wherein said reservoir is connected to said main body; said reservoir upper end having a reservoir opening, said reservoir opening having a reservoir opening mating surface and fastening means;
a fluid hose;
a sleeve including:
a sleeve body having a major axis and having a sleeve passageway through the major axis; said sleeve body having a sleeve upper end and a sleeve lower end, said sleeve passageway having a sleeve sealing means at said sleeve lower end, said sleeve passageway having a mounting seat for mounting a brake hose at sleeve upper end;
a cap integrally connected to said sleeve upper end, said cap having a cap mating surface and a fastening means;
a second master cylinder;
wherein said fluid hose connects said sleeve to said second master cylinder;
wherein said sleeve is disposed in said reservoir, said cap mating surface is coupled to said reservoir opening mating surface using said fastening means, wherein said sleeve passageway's sealing means provides a seal between said fluid passing port and said sleeve passageway preventing pressurized oil from reaching said reservoir chamber;
wherein said fluid passing port provides a supply of working oil from said second master cylinder through said sleeve passageway to the main body for braking; wherein said first master cylinder piston may generate hydraulic pressure in said main body chamber by moving from a first position where said fluid passing port is not sealed by said piston to a second position in which said piston seals said fluid passing port in said main body chamber in said second position; wherein said second master cylinder may generate hydraulic pressure to said main body chamber when said piston is in said first position, said sleeve sealing means preventing oil under hydraulic pressure from reaching said reservoir chamber.
